(19) United States
(12) Patent Application Publication
(10) Pub. No.: US 2016/0052751 A1
(43) Pub. Date: Feb. 25, 2016

(54) WORK TOOL ASSEMBLY

(71) Applicant: Caterpillar Work Tools B.V., s-Hertogenbosch (NL)

(72) Inventor: Peter LAUTERSLAGER, Oss (NL)

(73) Assignee: CATERPILLAR WORK TOOLS B.V., s-Hertogenbosch (NL)

(21) Appl. No.: 14/829,793

(22) Filed: Aug. 19, 2015

(30) Foreign Application Priority Data
Aug. 21, 2014 (GB) 1414855.5

(51) Int. Cl. B66C 1/36; B66C 1/34

(52) U.S. Cl. CPC B66C 1/36; B66C 1/34

(57) ABSTRACT

A work tool assembly for a work machine is disclosed. The work tool assembly may have a lifting hook. The work tool assembly may also have a work tool apparatus. Further, the work tool assembly may have an engaging device configured to releasably engage the lifting hook with the work tool apparatus. In addition, the work tool apparatus may have a securing arrangement configured to secure the lifting hook to the work tool apparatus.

### TECHNICAL FIELD

The present disclosure relates to a work tool assembly for a work machine, a work tool apparatus for a work machine, a lifting hook for a work tool apparatus and a locking device for locking a lifting hook in engagement with a work tool apparatus.

### BACKGROUND

Work machines, such as those machines used in the construction industry, may use various different work tools for achieving a particular function. For example, a work tool such as a bucket may be used to carry a load or may be used for digging purposes.

The work machine may be constructed so that the work tool is interchangeable with other work tools so as to maximise the different type of operations that can be performed by the work machine.

Often, a lifting hook may be cast or welded onto either the work machine or the work tool so as to provide a secondary operation (i.e. in addition to the primary operation performed by the work tool itself). Namely, the lifting hook may allow for a load to be engaged, lifted and then carried or transported.

### SUMMARY

According to one aspect of the present disclosure, there is provided a work tool assembly for a work machine, the work tool assembly comprising: a lifting hook; a work tool apparatus; an engaging means for enabling a releasable engagement of the lifting hook with the work tool apparatus; and a securing means for allowing the lifting hook to be secured to the work tool apparatus.

According to another aspect of the present disclosure, there is provided a work tool apparatus for a work machine, the work tool apparatus comprising: an engagement means for enabling a releasable engagement between the work tool apparatus and a lifting hook; and a securing means for allowing the lifting hook to be secured to the work tool apparatus.

According to another aspect of the present disclosure, there is provided a lifting hook for a work tool apparatus, the lifting hook comprising: a hook-shaped portion for enabling a load to be releasably engaged; an engagement means for enabling a releasable engagement between the lifting hook and a work tool apparatus; and a securing means for allowing the lifting hook to be secured to the work tool apparatus.

According to another aspect of the present disclosure, there is provided a locking device for locking a lifting hook in engagement with a work tool apparatus, the work tool apparatus having at least a first shaft for location in a first aperture of a conjoined aperture arrangement of the lifting hook, wherein the locking device comprises a blocking element for location in a second aperture of the conjoined aperture arrangement so as to prevent movement of the first shaft from the first aperture to the second aperture.

### BRIEF DESCRIPTION OF THE DRAWINGS

Aspects of the present disclosure will now be described, by way of example only, with reference to the following figures, in which:

FIG. 1 is a perspective view of a work tool assembly in accordance with an embodiment of the present disclosure;

FIG. 2 is a perspective view of a portion of a work tool apparatus in accordance with the embodiment of FIG. 1;

FIG. 3 is a perspective view of a lifting hook in accordance with the embodiment of FIG. 1;

FIG. 4 is a perspective view of a locking device in accordance with the embodiment of FIG. 1; and

FIG. 5 is an exploded view of the work tool assembly of FIG. 1, showing how the various elements may cooperate with one another.

### DETAILED DESCRIPTION

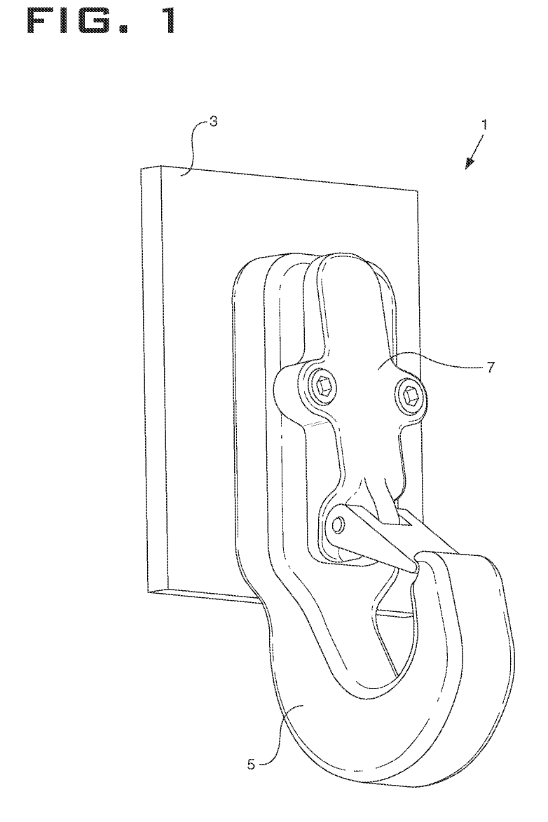

FIG. 1 shows a representation of a work tool assembly 1 that may be part of a machine (not shown). The machine may be any type of machine, for example a transportation vehicle, such as a car, truck, van, etc, a heavy equipment vehicle, for example a backhoe loader, bulldozer, tractor, etc, a water irrigator, an electricity generator, etc. The machine may be termed a “work” machine in that it may be used to perform work such as is typical for a machine used in construction, agriculture, quarries, paving, mining, forestry, waste and so forth. For example, a non-exhaustive list of work machines are as follows: articulated trucks, backhoe loaders, compactors, forest machines, hydraulic excavators, material handlers, motor graders, off-highway trucks, paving equipment, pipelayers, scapers, skid-steer loaders, track loaders, track-type tractors, underground mining equipment, wheel dozers, wheel excavators and wheel loaders.

The work tool assembly 1 may consist of at least: a work tool apparatus 3 such as a work implement or quick-coupling device, a lifting hook 5, and a locking device 7. The work tool apparatus 3, the lifting hook 5 and the locking device 7 may cooperate with one another in order to enable the lifting hook 5 to engage the work tool apparatus 3 via engaging means and to be secured to the work tool apparatus 3 via securing means. It will be appreciated that the engaging means and securing means (described in more detail herein with reference to FIG. 5) may each be formed from one or more features and therefore may not be labelled with reference to any one specific feature.

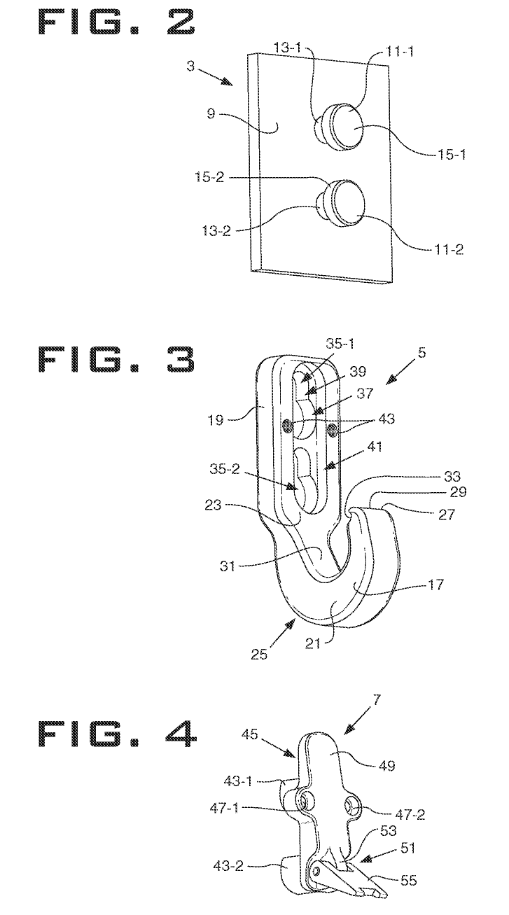

The individual parts shown in FIG. 1 are described in more detail herein with respect to FIGS. 2 to 5.

FIG. 2 is a perspective view of a work tool apparatus 3 according to an exemplary embodiment of the present disclosure. The work tool apparatus 3 may, for example, be a work implement for a work machine such as an excavation bucket, a ripper, a compactor, a pallet fork, a material handler arm, a multiprocessor (e.g. with exchangeable jaws for crushing, cutting and/or pulverising), a grapple, and so forth. In other examples, the work took apparatus 3 may be a quick-coupling device (often termed a “quick coupler”) for enabling a releasable connection between a work machine and a work implement, for example, so as to allow a quick interchange between work implements.

For simplification of explanation, the entire work tool apparatus 3 is not shown in FIG. 2, but instead, only a portion of a surface 9 of the work tool apparatus 3 is shown.

The work tool apparatus 3 comprises two protruding elements 11-1, 11-2, which protrude from the surface 9. In particular, each protruding element 11-1, 11-2 may comprise a shaft portion 13-1, 13-2 and a stop portion 15-1, 15-2. Each stop portion 15-1, 15-2 may be provided at an end of an associated shaft portion 13-1, 13-2 (i.e. the end of the shaft portion that is farthest from the surface 9). Each shaft portion 13-1, 13-2 may comprise a longitudinal axis which is orthogonal to a plane of the surface 9. The shaft portions 13-1, 13-2 of each protruding element 11-1, 11-2 may be in line with one another (i.e. in line along a single plane) such that the longitudinal axis of one shaft portion 13-1 is parallel to the other shaft portion 13-2. Each shaft portion 13-1, 13-2 may be substantially cylindrical. Each stop portion 15-1, 15-2 may be substantially disc-shaped. Each stop portion 15-1, 15-2 may be provided centrally around a respective shaft portion 13-1, 13-2 so that an outer periphery of each stop portion is equidistant from each respective longitudinal axis. A cross-sectional surface area (e.g. in a plane orthogonal to the direction of protrusion) of the stop portion 15-1, 15-2 may be greater than a cross-sectional surface area of the shaft portion 13-1, 13-2. A diameter of the stop portion 15-1, 15-2 may be greater than a diameter of the shaft portion 13-1, 13-2.

The protruding elements 11-1, 11-2 of the work tool apparatus 3 are each constructed and arranged so as to communicate with corresponding features on the lifting hook 5.

FIG. 3 shows a perspective view of the lifting hook 5. The lifting hook 5 may comprise a hook-shaped portion 17 for engaging a load (not shown) and a connection portion 19 for allowing the lifting hook 5 to be connected to the work tool apparatus 3. For example, the load may have an eyelet portion or looped rope so as to allow the load to be picked up. In this manner, the hook-shaped portion 17 can thread through the eyelet portion or looped rope so as to engage the load.

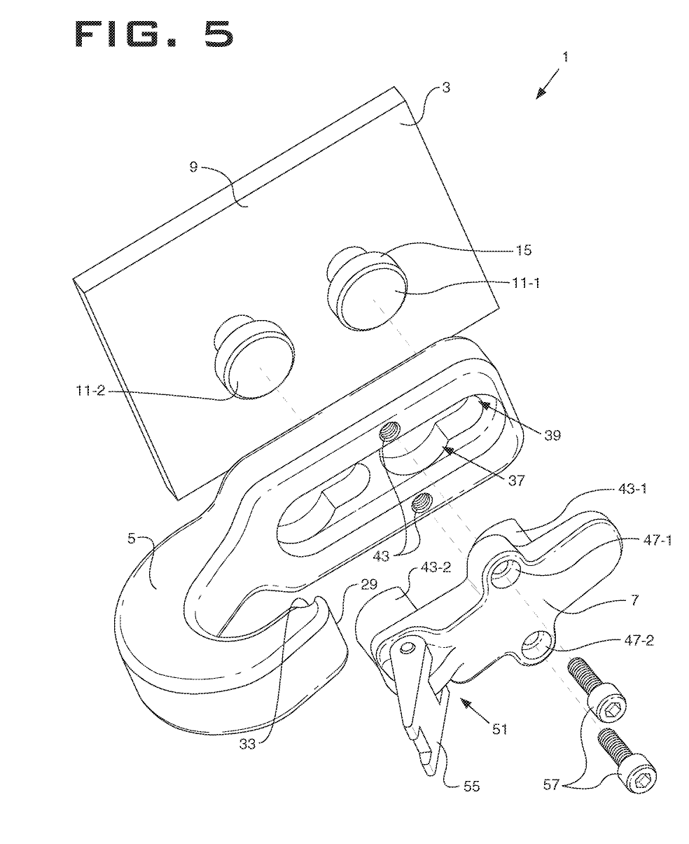

The hook-shaped portion 17 may comprise a curved body 21 that joins to the connection portion 19 at a first end 23. The curved body 21 may have a curved cross-section that has a maximum thickness towards a middle section 25 of the curved body 21. The thickness of the cross-section may inwardly taper from the middle section 25 towards the first end 23 so as to match the thickness of the connection portion 19 to which the hook-shaped portion 17 is joined. The cross-section may also inwardly taper from the middle section 25 towards a second end 27 to form an edge 29. The curved body 21 may comprise an engagement surface 31 that forms a part of an inner curvature of the curved body 21. The engagement surface 31 may be configured to engage and support the load. A recess portion 33 may be formed on the engagement surface 31 adjacent to the edge 29. The recess portion 33 may cooperate with a latch of the locking device, described in more detail herein with reference to FIG. 4.

The connection portion 19 may comprise two ports 35-1, 35-2 for communication with the protruding elements 11-1, 11-2 of the work tool apparatus 3. Each port 35-1, 35-2 may comprise a first aperture 37. Each port 35-1, 35-2 may comprise a second aperture 39 that is conjoined with the first aperture 37. The first aperture 37 may be constructed and arranged to receive the stop portion 15 and shaft portion 13 of the work tool apparatus 3. Accordingly, the first aperture 37 may be sized to allow the stop portion 15 to be threaded through the first aperture 37. The second aperture 39 may have a smaller cross-sectional area than that of the first aperture 37 and may be sized to prevent the stop portion 15 from being threaded through the second aperture 39. The second aperture 39 may be sized to allow the shaft portion 13 to be received.

For example, the first aperture 37 may have a diameter larger than a diameter of the second aperture 39. The diameter of the first aperture 37 may be larger than a diameter of the stop portion 15. The second aperture 39 may have a smaller diameter compared with that of a diameter of the first aperture 37. The diameter of the second aperture 39 may be smaller than that of the diameter of the stop portion 15 but larger than that of a diameter of the shaft portion 13.

In this manner, the lifting hook 4 may be initially positioned so that the first apertures 37 of the ports 35-1, 35-2 are placed around the protruding elements 11-1, 11-2. The lifting hook 4 may then be moved relative to the work tool apparatus 3, so that the shaft portions 13 may slide into the second apertures 39. In this position, the stop portions 15 substantially prevent axial movement of the lifting hook 4 with respect to the work took apparatus 3 (i.e. movement along the longitudinal axis of the shaft portions 13).

The ports 35-1, 35-2 may be provided in a recessed area 41 of the connection portion 19.

Two holes 43 may be provided in the connection portion 19 to allow the locking device 7 to be fixed to the connection portion 19.

FIG. 4 is a perspective view of the locking device 7. The locking device 7 may comprise two blocking elements 43-1, 43-2 which protrude from a rear face 45 of the locking device 7. The blocking elements 43-1, 43-2 may each be sized so as to at least partly fill a first aperture 37 when placed within the first aperture 37. Each blocking element 43-1, 43-2 may be constructed with an outer shape that at least partially conforms to the shape of a respective first aperture 37. The locking device 7 may comprise fixture portions 47-1, 47-2 for enabling the locking device 7 to be secured to the lifting hook 5, for example, using fixings (not shown) such as screws or the like. The locking device 7 may comprise a front face 49 upon which a latch mechanism 51 may be disposed. The latch mechanism 51 may comprise a hinge 53 and a latch 55. The latch 55 may be connected to the hinge 53 in a manner so that it may pivot about the hinge 53. The latch mechanism 51 may be biased to a raised position via a spring-type arrangement (not shown). The latch 55 is arranged to communicate with the recessed portion 33 of the lifting hook 5. The raised position may be such that a closed loop may be formed by the latch 55 and at least the hook-shaped portion 21 and the locking device 7 when the work tool assembly 1 is completed. The closed loop may thereby prevent an eyelet or looped rope associated with a load from readily disengaging from the lifting hook 5.

In the above examples described with reference to FIGS. 1 to 5, two protruding elements 11-1, 11-2 were described. However, it will be appreciated that in other examples, one or more protruding elements may be used. Fewer protruding elements may provide a simpler arrangement with material reduction and associated cost savings. Greater protruding elements may provide stability to the assembly and a greater load-bearing capacity (i.e. due to an increased surface area for load distribution). In some examples, the protruding element may have a non-circular cross-section. In the case of a single protruding element, the non-circular cross-section may provide stability for a connecting structure and may prevent the connecting structure from rotating around the protruding element. In this regard, the connecting structure may have a correspondingly shaped aperture arrangement to follow the contour of the protruding element. For example, the non-circular cross-section may be substantially rectangular or square in shape.

In the above examples described with reference to FIGS. 1 to 5, the protruding elements 11-1, 11-2 where described to be comprised of a shaft portion 13 and a disc-shaped stop portion 15. In alternative examples, the cylindrical shaft portion 13 and disc-shaped stop portion 15 may be replaced with different shapes such as a cuboid portion with a cube stop portion. In this regard, it will be appreciated that various shape combinations are possible to achieve the effect of enabling an engagement and securing of the lifting hook with the work tool apparatus, as long as the cross-sectional surface area of the top portion exceeds that of the shaft portion.

In the exemplary embodiments described herein with reference to FIGS. 1 to 5, an interface is provided between the lifting hook 5 and the work tool apparatus 3 as a “plug and socket” type arrangement, whereby the protruding elements 11 comprise the “plug” portion of the arrangement and the ports 35 comprise the “socket” portion of the arrangement. It will be appreciated that, in other examples, the reverse plug and socket arrangement is possible, whereby the protruding elements 11 may be provided on the lifting hook 5 rather than on the work tool apparatus 3, and whereby the ports 35 may be provided on the work tool apparatus 3 rather than on the lifting hook 5.

In the exemplary embodiments described herein with reference to FIG. 4, a locking device 7 was described to have blocking elements 43 that may be inserted into the first apertures 37 so as to prevent disengagement of the lifting hook 5 from the work tool apparatus 3. In alternative examples, the blocking elements 43 may not extend into the first apertures 37 but may instead cooperate with the stop portions 15 of the protruding elements 11 so as to prevent the relative movement between the work tool apparatus 3 and the lifting hook 5.

### INDUSTRIAL APPLICABILITY

The work tool assembly described above may be implemented in any work machine, for example, a work machine as described herein with reference to FIG. 1.

FIG. 5 shows an exploded view of the work tool assembly 1, illustrating how the work tool apparatus 3, the lifting hook 5 and the locking device 7 may cooperate with one another.

In this example, the work tool apparatus 3 may be casted into the surface of a quick-coupler, such that the surface 9 of the work tool apparatus 3 is that of the quick-coupler.

The lifting hook 5 may be moved into engagement with the work tool apparatus 3 by aligning the first apertures 37 of the lifting hook 5 with the protruding elements 11-1, 11-2 of the work tool apparatus 3. Once aligned, the lifting hook 5 may be moved so as to allow the protruding elements 11-1, 11-2 to thread through the first apertures 37. The lifting hook 5 may then be moved so as to allow the shaft portions 13 of the work tool apparatus 3 to slide from the first apertures 37 into the second apertures 39 of the conjoined aperture arrangements. When the protruding elements 11-1, 11-2 are aligned along a vertical axis, gravity may allow the lifting hook 5 to slide down and be retained in position. The stop portions 15 and second apertures 39 may prevent the lifting hook 5 from disengaging from the work tool apparatus 3 in an axial manner. Therefore, in order to disengage the lifting hook 5 from the work tool apparatus 3, the lifting hook 5 may first slide up and then be pulled away from the work tool apparatus 3.

After having engaged the lifting hook 5 with the work tool apparatus 3 such that the shaft portions 13 are located in the second apertures 39, the locking device 7 may then be used to lock the lifting hook 5 to the work tool apparatus 3. This may be done by placing the locking device 7 so that the blocking elements 43-1, 43-2 are inserted into the first apertures 37 of the lifting hook 5. Fixtures 57, such as screws or the like, may then be inserted into the fixture portions 47-1, 47-2 of the locking device 7 and through to the holes 43 of the lifting hook 5 so as to secure the locking device 7 to the lifting hook 5. As the first apertures 37 may be at least partly blocked by the blocking elements 43-1, 43-2, the protruding elements 11-1, 11-2 may be prevented from sliding into the first apertures 37 from the second apertures 39. The lifting hook 5 may thereby be prevented from disengaging from the work tool apparatus 3 without first removing the locking device 7.

When the locking device 7 is secured to the lifting hook 5, the latch 55 of the latch mechanism 51 may communicate with the hook-shaped portion 17 of the lifting hook 5. For example, the recess portion 33 of the lifting hook 5 may provide an abutment surface to prevent the latch 55 from extending past the edge 29 of the lifting hook 5 due to the spring-bias of the latch mechanism 51. However, the latch 55 may be “opened” by pushing the latch 55 against the spring-bias so as to allow the lifting hook 5 to engage a load.

The term “engaging means” as used herein may refer to any feature of the work tool assembly 1, which allows the lifting hook 5 to engage the work tool apparatus 3. For example, the engaging means may comprise one or more of the protruding element 11, the shaft portion 13, the stop portion 15, the port 35, the first aperture 37 and the second aperture 39.

The term “securing means” as used herein may refer to any feature of the work tool assembly 1, which allows the lifting hook 5 to be secured to the work tool apparatus 3 (i.e. to prevent disengagement of the lifting hook 5 from the work tool apparatus 3). For example, the securing means may comprise one or more of the stop portion 15, the second aperture 39, the locking device 7, the blocking elements 43 and the fixings 57.

1. A work tool assembly for a work machine, the work tool assembly comprising:
a lifting hook;
a work tool apparatus;
an engagement device configured to releasably engage the lifting hook with the work tool apparatus; and
a securing arrangement configured to secure the lifting hook to the work tool apparatus.

2. A work tool assembly according to claim 1, wherein the engagement device includes a plug and socket arrangement.

3. A work tool assembly according to claim 1, wherein the securing arrangement includes a locking mechanism configured to selectively lock the lifting hook with the work tool apparatus.

4. A work tool assembly according to claim 1, wherein the engagement device includes a shaft that protrudes from a surface of one of the lifting hook and the work tool apparatus.

5. A work tool assembly according to claim 4, wherein the engagement device includes a first aperture disposed in the surface of one of the lifting hook and the work tool so as to communicate with the shaft.

6. A work tool assembly according to claim 5, wherein the securing arrangement includes a second aperture that is conjoined with the first aperture.

7. A work tool assembly according to claim 6, wherein the second aperture comprises a cross-sectional area that is smaller than a cross-sectional area of the first aperture.

8. A work tool assembly according to claim 7, wherein the securing arrangement includes a stop portion arranged at an end of the shaft, the stop portion having a cross-sectional area that is larger than a cross-sectional area of the shaft.

9. A work tool assembly according to claim 8, wherein the first aperture is sized to receive the stop portion.

10. A work tool assembly according to claim 9, wherein the stop portion is disc shaped.

11. A work tool assembly according to claim 8, wherein the cross-sectional area of the second aperture is larger than the cross-sectional area of the shaft but smaller than a cross-sectional area of the stop portion.

12. A work tool assembly according to claim 6, wherein the securing arrangement includes a blocking device for insertion into the first aperture for at least partly blocking the first aperture.

13. A work tool apparatus for a work machine, the work tool apparatus comprising:
an engagement device configured to releasably engage the work tool apparatus and a lifting hook; and
a securing arrangement configured to secure the lifting hook to the work tool apparatus.

14. A work tool apparatus according to claim 13, wherein the engagement device includes a shaft which protrudes from a surface of the work tool apparatus for communication with the lifting hook.

15. A work tool apparatus according to claim 14, wherein the securing arrangement includes a stop portion provided at an end of the shaft.

16. A work tool apparatus according to claim 15, wherein the stop portion comprises a diameter that is larger than a diameter of the shaft.

17. A work tool apparatus according to claim 15, wherein the stop portion is disc shaped.

18. A work tool apparatus according claim 15, wherein the stop portion is sized to be received by a first aperture of a conjoined aperture arrangement provided on a lifting hook and wherein the shaft is sized to be received by a second aperture of the conjoined aperture arrangement.

19. A work tool apparatus according to claim 13, wherein the work tool apparatus is one of a work implement for a work machine, and a quick-coupling device for enabling a releasable connection between a work machine and a work implement.

20. A lifting hook for a work tool apparatus, the lifting hook comprising:
a hook-shaped portion configured to releasably engage a load;
an engagement device configured to releasably engage the lifting hook and a work tool apparatus; and
a securing arrangement configured to secure the lifting hook the work tool apparatus.

21. A lifting hook according to claim 20, wherein the engaging device includes a first aperture disposed in the surface of the lifting hook.

22. A lifting hook according to claim 21, wherein the securing arrangement includes a second aperture that is conjoined with the first aperture.

23. A lifting hook according to claim 22, wherein the second aperture comprises a diameter that is smaller than a diameter of the first aperture.

24. A lifting hook according to claim 23, wherein the first aperture is sized to receive a stop portion of a shaft of a work tool apparatus and wherein the second aperture is sized to receive the shaft of the work tool apparatus.

25. A locking device for locking a lifting hook in engagement with a work tool apparatus, the work tool apparatus having at least a first shaft for location in a first aperture of a conjoined aperture arrangement of the lifting hook, wherein the locking device comprises a blocking element for location in a second aperture of the conjoined aperture arrangement so as to prevent movement of the first shaft from the first aperture to the second aperture.

26. A locking device according to claim 25, comprising a latch mechanism for communication with the lifting hook, the latch mechanism comprising a latch pivotably connected to the locking device.

27. A locking device according to claim 26, wherein the latch comprises an abutment portion for abutment with a hook portion of the lifting hook.
